(19) United States
(12) Patent Application Publication
(10) Pub. No.: US 2026/0178702 A1
(43) Pub. Date: Jun. 25, 2026

(54) SYSTEMS AND METHODS FOR PERFORMING LINE CLEARANCE AND MONITORING

(71) Applicant: AMGEN INC., Thousand Oaks, CA (US)

(72) Inventors: Thomas Clark Pearson, Newbury Park, CA (US); Tyler Bellenfant, Ventura, CA (US); Al Patrick Goodwin, Dunleer (IE)

(21) Appl. No.: 19/126,892

(22) PCT Filed: Nov. 2, 2023
(86) PCT No.: PCT/US23/36647

§ 371 Date: May 2, 2025

Related U.S. Application Data
(60) Provisional application No. 63/422,720, filed on Nov. 4, 2022.

(51) Int. Cl. G06F 18/214; G06F 3/0482; G06N 20/00; G06T 7/20; G06T 7/246

(52) U.S. Cl. CPC G06F 18/214; G06F 3/0482; G06N 20/00; G06T 7/20; G06T 7/246; G06T 2207/20081

(57) ABSTRACT

Systems and methods of performing line clearance and monitoring are disclosed herein. An example method includes receiving a first and second set of images of a manufacturing line during a run-time operation of the manufacturing line, the first set of images representing a first field of view (FOV) that is oriented to capture objects while falling from the manufacturing line, and the second set of images representing a second FOV that is different from the first FOV and oriented to capture objects positioned below the manufacturing line. The example method further includes analyzing the first set of images to identify a falling object; and analyzing the second set of images to identify a stationary object. The example method further includes, responsive to identifying the falling object or the stationary object, causing a display to present a notification that includes an image of the falling object or the stationary object.

### FIELD OF THE DISCLOSURE

The present application relates generally to the use of imaging systems and image analysis algorithms to identify unexpected items on or near a manufacturing line. More specifically, the present application relates to systems and methods for performing line clearance and monitoring in biopharmaceutical processes and applications.

### BACKGROUND

There exists a multitude of manufacturing processes that require the reconciliation between input materials of a process with output materials of the process. The procedure for achieving this reconciliation is generally known as line clearance. Line clearance is a prominent issue particularly on biopharmaceutical manufacturing lines, and conventionally involves a standardized procedure for ensuring that equipment and work areas are free of products, documents, and materials from a previous process (e.g., manufacturing line run). Broadly, line clearance procedures help operators prepare for the next scheduled process and avoid mislabeling or cross-contamination of finished products.

However, conventional line clearance procedures suffer from numerous drawbacks. Namely, conventional line clearance procedures involve operators manually clearing packaging lines after each lot, and manually inspecting all areas of the manufacturing line to ensure no components or materials have remained at the conclusion of a process. This conventional procedure is time consuming, can require two-person verifications, and generally raises safety and ergonomic concerns for the human operators involved. Moreover, as both the physical inspection operations and the documentation completion of conventional procedures is almost entirely manual, these conventional procedures often introduce a significant amount of human error. As a result, these conventional line clearance procedures inevitably delay subsequent manufacturing operations, place operators in compromising/dangerous positions within the manufacturing line to conduct the manual inspections, yield mislabeled or cross-contaminated products from manual error, and/or result in hazardous conditions when the manual inspections miss or otherwise overlook stray objects in the manufacturing line.

Accordingly, there is a need for line clearance systems and methods for performing line clearance and monitoring in biopharmaceutical processes and applications that enables operators to easily, efficiently, and safely monitor and clear manufacturing lines during and after live operations.

### BRIEF SUMMARY

Generally, the systems and methods of the present disclosure may include a camera system that may be placed on a benchtop, or on a manufacturing line, to remotely view and record video and images of the manufacturing line and surrounding areas on a network. The camera(s) may run a motion detection or machine learning (ML) algorithm to record and save a video when anomalous events (e.g., falling objects or stationary objects) occur outside of expected regions, and can notify users/operators in real-time. For example, the systems and methods of the present disclosure may provide immediate notification(s) of dropped or dislodged product(s) that travel through manufacturing lines, and may provide video/image evidence of the final location of the dropped or dislodged product, which decreases downtime and increases overall line clearance quality. The live/real-time video and recorded video may be accessed within enterprise networks, manufacturing networks, and/or private cloud servers, and the recorded video may be stored for historical reference/records. Further, the systems and methods of the present disclosure are modular, such that any number of devices may be used on a single manufacturing line, and these devices may be coordinated using on-premises or remote computer systems. The systems and methods of the present disclosure may include multiple cameras installed at select locations in, near, around, and/or otherwise proximate to the manufacturing line to provide a large field of view (FOV) corresponding to the manufacturing line. The systems and methods of the present disclosure may also enable a user/operator to view the processes and line clearance operations associated with the manufacturing line in real-time through live camera feeds.

Overall, the systems and methods of the present disclosure may yield significant advantages over conventional techniques, at least including: (1) substantial (e.g., approximately 60%) reduction in time spent performing line clearance, monitoring, and reconciliation; (2) increased manufacturing line production time/up-time (e.g., approximately 20 days per year); (3) increase in safety and a corresponding reduction in ergonomic issues due to elimination of manual inspections of hard-to-reach and/or otherwise hazardous areas within a manufacturing line; and (4) fewer issues/deviations in manual clearance and documentation operations due to a universal reduction in human-introduced error.

In particular, aspects of the present disclosure provide a computer-implemented method for performing line clearance and monitoring, comprising: receiving, by one or more processors, a first set of images of a manufacturing line during a run-time operation of the manufacturing line, the first set of images representing a first field of view (FOV) that is oriented to capture objects while falling from the manufacturing line; receiving, by the one or more processors, a second set of images of the manufacturing line during the run-time operation of the manufacturing line, the second set of images representing a second FOV that is different from the first FOV and oriented to capture objects positioned below the manufacturing line; analyzing, by the one or more processors, the first set of images and the second set of images to identify (i) a falling object within the first FOV or (ii) a stationary object within the second FOV; and responsive to identifying the falling object or the stationary object, causing, by the one or more processors, a display to present a notification, wherein the notification includes an image of the falling object or the stationary object.

In some aspects, generating the notification further comprises: responsive to identifying the falling object or the stationary object, triggering, by the one or more processors, a recording of multiple images from either the first set of images or the second set of images, each image of the multiple images depicting the falling object or the stationary object; and causing, by the one or more processors, a display to present the notification, wherein the notification includes the recording.

In certain aspects, the computer-implemented further comprises: masking a portion of the first set of images or the second set of images prior to analyzing the first set of images or the second set of images, the portion of the first set of images or the second set of images corresponding to one or more moving components of the manufacturing line.

In some aspects, generating the notification further comprises: generating the notification substantially in real-time for display at the user computing device in response to identifying the falling object or the stationary object, wherein the notification comprises at least one of: (i) an email message, (ii) a text message, or (iii) a line monitoring application alert.

In certain aspects, analyzing the first set of images and the second set of images may further comprise analyzing, by the one or more processors, the first set of images by applying a first algorithm and the second set of images by applying a second algorithm to identify (i) the falling object within the first FOV or (ii) the stationary object within the second FOV. In these aspects, both the first algorithm and the second algorithm may be, for example, a motion detection algorithm or a ML algorithm/model. Additionally, in these aspects, the first algorithm may be (i) a motion detection algorithm or (ii) a machine learning (ML) algorithm trained with a plurality of training data comprising a plurality of training images representing the manufacturing line, and wherein the ML algorithm is configured to receive image data of the manufacturing line as input and to output an anomaly score corresponding to a confidence level associated with detection of the falling object or the stationary object; and the second algorithm is (i) the motion detection algorithm or (ii) the ML algorithm. Further in these aspects, the computer-implemented may further comprise: training the ML model using the plurality of training images representing the manufacturing line, wherein the plurality of training images represent the manufacturing line operating (i) without a falling object within the first FOV and (ii) without a stationary object within the second FOV. Moreover, in these aspects, the ML algorithm may be at least one of (i) an anomaly detection algorithm, (ii) an image classification algorithm, or (iii) an object detection algorithm.

Another aspect of the present disclosure provides a computer system for performing line clearance and monitoring including, one or more processors; and a program memory coupled to the one or more processors and storing executable instructions that, when executed by the one or more processors, cause the computer system to perform the method of any one of the previous aspects.

Further aspects of the present disclosure provide a tangible, non-transitory computer-readable medium storing executable instructions for performing line clearance and monitoring, that when executed by one or more processors of a computer system, cause the computer system to perform the method of any one of the previous aspects.

In accordance with the above, and with the disclosure herein, the present disclosure includes improvements in computer functionality or in improvements to other technologies at least because the present disclosure describes that, e.g., line clearance and monitoring systems, and their related various components, may be improved or enhanced with the disclosed methods, computer systems, and tangible, non-transitory computer-readable mediums that provide more accurate, efficient, and safer performance of line clearance and monitoring procedures. That is, the present disclosure describes improvements in the functioning of a line clearance and monitoring system itself or “any other technology or technical field” (e.g., the field of line clearance and monitoring) because the disclosed methods, computer systems, and tangible, non-transitory computer-readable mediums improve and enhance operation of line clearance and monitoring systems by introducing imaging devices incorporating multiple algorithms that are specifically configured to monitor/analyze active manufacturing line operations and thereby eliminate errors and inefficiencies typically experienced over time by line clearance and monitoring systems lacking such methods, computer systems, and tangible, non-transitory computer-readable mediums. This improves over the prior art at least because such previous systems are error-prone, as they lack the ability to accurately, consistently, or efficiently analyze line clearance and perform line monitoring.

In addition, the present disclosure includes applying various features and functionality, as described herein, with, or by use of, a particular machine, e.g., imaging devices, computing systems, and/or other hardware components as described herein.

Moreover, the present disclosure includes effecting a transformation or reduction of a particular article to a different state or thing, e.g., transforming or reducing the error rate and/or the down-time of a manufacturing line from a non-optimal or error state to an optimal state as a result of accurate line clearance and monitoring based on real-time video and/or image analysis by multiple algorithms specifically configured to analyze particular areas of the manufacturing line.

Still further, the present disclosure includes specific features other than what is well-understood, routine, conventional activity in the field, or adding unconventional steps that demonstrate, in various embodiments, particular useful applications, e.g., analyzing, by applying a first algorithm, the first set of images to identify a falling object within the first FOV; analyzing, by applying a second algorithm, the second set of images to identify a stationary object within the second FOV; and generating a notification for display at a user computing device, wherein the notification includes an image of the falling object or the stationary object.

Additional advantages of the presently disclosed techniques over conventional approaches of line clearance and monitoring will be appreciated throughout this disclosure by one having ordinary skill in the art. The various concepts and techniques introduced above and discussed in greater detail below may be implemented in any of numerous ways, and the described concepts are not limited to any particular manner of implementation. Examples of implementations are provided below for illustrative purposes.

### BRIEF DESCRIPTION OF THE DRAWINGS

The skilled artisan will understand that the figures described herein are included for purposes of illustration and are not limiting on the present disclosure. The drawings are not necessarily to scale, emphasis instead being placed upon illustrating the principles of the present disclosure. It is to be understood that, in some instances, various aspects of the described implementations may be shown exaggerated or enlarged to facilitate an understanding of the described implementations. In the drawings, like primary characters throughout the various drawings generally refer to functionally similar or structurally similar components.

FIGS. 1A and 1B are simplified block diagrams of example systems for performing line clearance and monitoring in biopharmaceutical processes and applications, in accordance with various aspects disclosed herein.

FIGS. 2A and 2B depict example implementations of imaging devices/systems within a manufacturing line to perform line clearance and monitoring, in accordance with various aspects disclosed herein.

FIGS. 3A-3D depict example line clearance and monitoring analysis actions performed as part of the execution of a line monitoring application, in accordance with various aspects disclosed herein.

FIG. 4 depicts an example user interface presented by the line monitoring application that includes notifications to the user, in accordance with various aspects disclosed herein.

FIG. 5 is a flow diagram depicting an example method for performing line clearance and monitoring in biopharmaceutical processes and applications, in accordance with various aspects disclosed herein.

### DETAILED DESCRIPTION

### Exemplary Systems

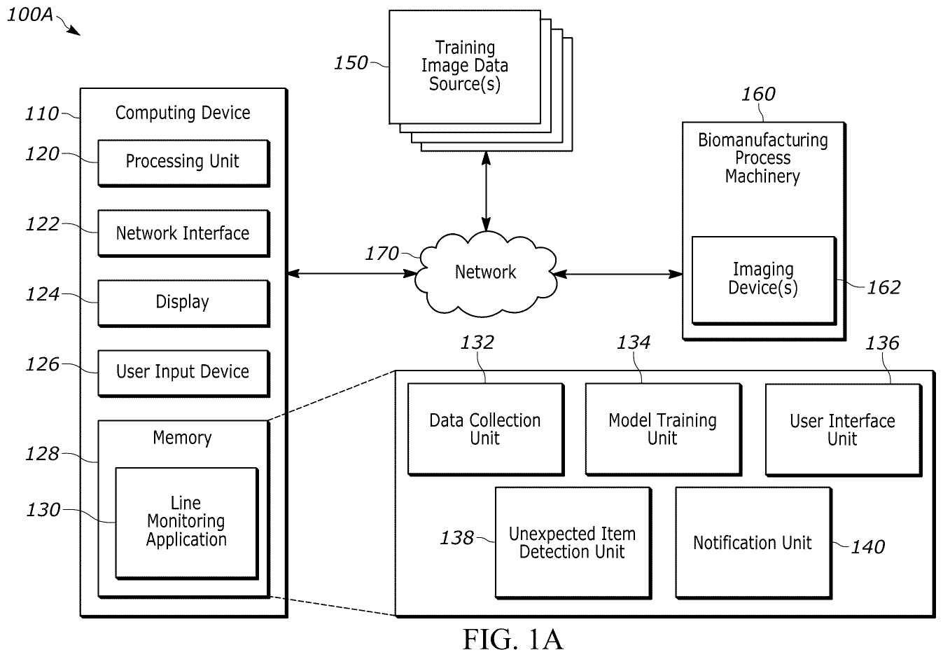

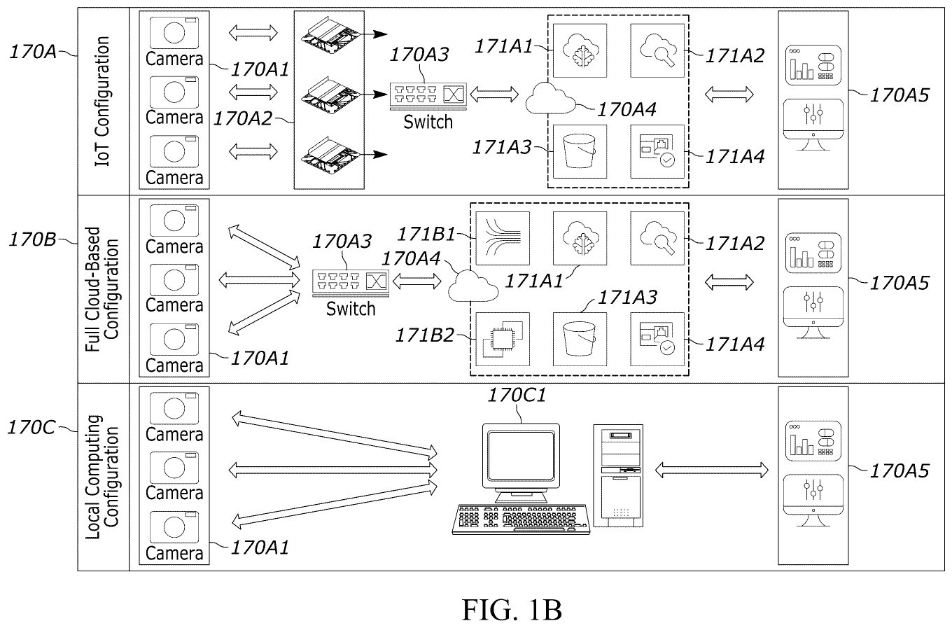

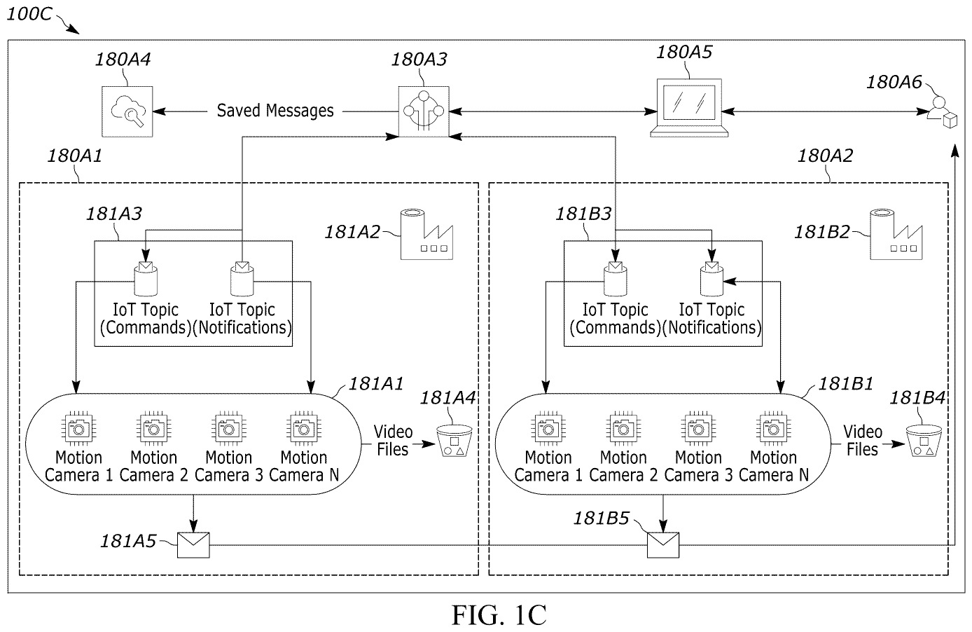

FIG. 1A is a simplified block diagram of an example system 100A for performing line clearance and monitoring in biomanufacturing process machinery 160, which, for example, may produce a drug product. In some embodiments, the system 100A includes standalone equipment, though in other embodiments the system 100A is incorporated into other equipment. At a high level, the system 100A includes components of a computing device 110, one or more training image data sources 150, the biomanufacturing process machinery 160, and one or more imaging devices 162. In FIG. 1A, the computing device 110, the biomanufacturing process machinery 160, and the training image data sources 150 are communicatively coupled via a network 170, which may be or include a proprietary network, a secure public internet, a virtual private network, and/or any other type of suitable wired or wireless network(s) (e.g., dedicated access lines, satellite links, cellular data networks, combinations of these, etc.). In embodiments where the network 170 comprises the Internet, data communications may take place over the network 170 via an Internet communication protocol. In some aspects, more or fewer instances of the various components of the system 100A than are shown in FIG. 1A may be included in the system 100A (e.g., one instance of the computing device 110, ten instances of the biomanufacturing process machinery 160, ten instances of the imaging devices 162, two instances of the training image data sources 150, etc.).

It is worth noting that while the system 100A is illustrated as including the biomanufacturing process machinery 160, one of ordinary skill in the art will understand that the present techniques and components of the system 100A may be applied to performing line clearance and monitoring in other processes or fields. For example, instead of the biomanufacturing process machinery 160, the present techniques and components of the system 100A may be applied to manufacturing in food/beverage, automotive, electronic, chemical, and/or other industries.

The biomanufacturing process machinery 160 may include a single biomanufacturing process machine, or multiple biomanufacturing process machines that are either co-located or remote from each other and are suitable for producing biological products, such as drug products. The biomanufacturing process machinery 160 may generally include physical devices configured for use in producing (e.g., manufacturing) biological products (e.g., drug products), such as filling devices, agitating devices, starwheels or other vessel conveyances, and so on.

The biomanufacturing process machinery 160 may, in some embodiments, be connected with the computing device 110 either via the network 170, or directly, allowing for at least some of the functionality of the biomanufacturing process machinery 160 to be controlled by the computing device 110. In some embodiments, the biomanufacturing process machinery 160 may be capable of receiving instruction directly from a user (e.g., the biomanufacturing process machinery 160 may be manually-configurable). For example, in some embodiments, the biomanufacturing process machinery 160 may receive instructions directly from a user to control operation (e.g., start or stop operation).

The imaging devices 162 may be included in the biomanufacturing process machinery 160 (e.g., integrated into the biomanufacturing process machinery 160) or may be external devices connected to and/or otherwise located proximate to the biomanufacturing process machinery 160. The imaging devices 162 may be used to collect video/image data inside, outside, and/or around the biomanufacturing process machinery 160. The imaging devices 162 may provide the video/image data to, for example, the computing device 110 (e.g., via the network 170). The video/image data may be any suitable data type, such as real-time video data of a manufacturing line included as part of the biomanufacturing process machinery 160, single image frames of the manufacturing line, and/or any other suitable data type or combinations thereof. The video/image data may be collected or provided automatically, or in response to a request. For example, a user of the computing device 110 may wish to monitor the manufacturing line in the biomanufacturing process machinery 160 over a period of time. In response, one or more of the imaging devices 162 may collect and provide the video/image data of the manufacturing line to the computing device 110 over the period of time, and/or may transmit a live video stream of the manufacturing line to the computing device 110 over the period of time or a portion thereof. In some aspects, the imaging devices 162 may collect video/image data in response to the biomanufacturing process machinery 160 operating. For example, the imaging devices 162 may begin collecting video/image data when the biomanufacturing process machinery 160 is powered on/begins operation and may continue collecting video/image data until the biomanufacturing process machinery 160 is powered off/ends operation.

The biomanufacturing process machinery 160 may include one or more devices (not shown) used in manufacturing of biological products (e.g., drug products, as discussed in the Background Section). The biomanufacturing process machinery 160 may be configured to be controllable via manual or automated inputs. In some embodiments, the biomanufacturing process machinery 160 may be configured to receive such control inputs locally, such as via a user input device local to the biomanufacturing process machinery 160. In some embodiments, the biomanufacturing process machinery 160 is configured to receive control inputs remotely, such as from the computing device 110 (e.g., via the network 170). The control inputs may include operation instructions, such as instructing the biomanufacturing process machinery 160 to power on/begin operation. In some aspects, the biomanufacturing process machinery 160 may end operation in response to one or more of: (i) the biomanufacturing process machinery 160 completing production of biological product (e.g., a full batch of drug product is finished), (ii) an instruction from the line monitoring application 130 related to line clearance and monitoring, or (iii) receiving a manual instruction to end operation.

The training image data sources 150 generally include training video/image data that may correspond to (e.g., may have been collected during performance of) one or more biomanufacturing processes for producing one or more biological products using the biomanufacturing process machinery 160. The training video/image data may represent: (i) manufacturing line components, (ii) a manufacturing line floor area, (iii) a manufacturing line interior (e.g., gaps between components, etc.), and/or other suitable areas or portions of areas related to the manufacturing line. Further, the training video/image data may have been collected (by computing device 110 or another device/system) using image device(s) 162 or other, similar sensors. In some aspects, the training video/image data includes image data corresponding to each component and region of the manufacturing line. As such, the imaging device(s) 162 may have a collective field of view (FOV) that includes each component and/or region of the manufacturing line, such that the models and algorithms described herein may be trained and/or otherwise configured to analyze subsequent run-time image data of any component or region of the manufacturing line based on the training video/image data. In some embodiments, the system 100A may omit the training image data sources 150, and instead receive the training video/image data locally, such as via user input at the computing device 110 (e.g., a user providing a portable memory drive with the training video/image data). In some examples, the training video/image data includes video/image data that does not include any unexpected and/or otherwise rogue items (e.g., product containers) that is combined (or mixed) with second video/image data that includes an item. In these examples, the training image data sources 150 or the computing device 110 may augment (or combine) the first video/image data and the second video/image data using techniques such as Poisson image blending, seamless cloning, or the like.

The computing device 110 may include a single computing device, or multiple computing devices that are either co-located or remote from each other. The computing device 110 is generally configured to input video/image data over a period of interest to at least one model/algorithm (e.g., trained using training video/image data) to analyze the video/image data to identify a falling object within a first FOV and/or a stationary object within a second FOV. Components of the computing device 110 may be interconnected via an address/data bus or other means. The components included in the computing device 110 may include a processing unit 120, a network interface 122, a display 124, a user input device 126, and a memory 128, discussed in further detail below.

The processing unit 120 includes one or more processors, each of which may be a programmable microprocessor that executes software instructions stored in the memory 128 to execute some or all of the functions of the computing device 110 as described herein. Alternatively, one or more of the processors in the processing unit 120 may be other types of processors (e.g., application-specific integrated circuits (ASICs), field-programmable gate arrays (FPGAs), etc.).

The network interface 122 may include any suitable hardware (e.g., front-end transmitter and receiver hardware), firmware, or software configured to use one or more communication protocols to communicate with external devices or systems (e.g., the imaging devices 162, the biomanufacturing process machinery 160, the training image data sources 150, etc.) via the network 170. For example, the network interface 122 may be or include an Ethernet interface.

The display 124 may use any suitable display technology (e.g., LED, OLED, LCD, etc.) to present information to a user, and the user input device 126 may be a keyboard or other suitable input device. In some aspects, the display 124 and the user input device 126 are integrated within a single device (e.g., a touchscreen display). Generally, the display 124 and the user input device 126 may combine to enable a user to interact with graphical user interfaces (GUIs) or other (e.g., text) user interfaces provided by the computing device 110 (e.g., for purposes such as notifying users of line clearance/monitoring actions, etc.).

The memory 128 includes one or more physical memory devices or units containing volatile or non-volatile memory, and may or may not include memories located in different computing devices of the computing device 110. Any suitable memory type or types may be used, such as read-only memory (ROM), solid-state drives (SSDs), hard disk drives (HDDs), etc. The memory 128 may store instructions for one or more software applications included in a line monitoring application 130 that can be executed by the processing unit 120. In the example system 100A, the line monitoring application 130 includes a data collection unit 132, a model training unit 134, a user interface unit 136, a unexpected item detection unit 138, and a notification unit 140. The units 132-140 may be distinct software components or modules of the line monitoring application 130, or may simply represent functionality of the line monitoring application 130 that is not necessarily divided among different components/modules. For example, in some embodiments, the data collection unit 132 and the user interface unit 136 are included in a single software module. Moreover, in some embodiments, the units 132-140 may be distributed among multiple copies of the line monitoring application 130 (e.g., executing at different components in the computing device 110), or among different types of applications stored and executed at one or more devices of the computing device 110.

The data collection unit 132 is generally configured to receive data (e.g., video/image data, operator instructions, etc.). In some embodiments, the data collection unit 132 receives the training video/image data (e.g., including historical video/image data of a plurality of instances of the biomanufacturing process and corresponding historical video/image data) of a biomanufacturing process for producing a biological product. The data collection unit 132 may receive the training video/image data via, for example, the training image data sources 150, user input received via the user interface unit 136 with the user input device 126, or other suitable means. In some embodiments, the data collection unit 132 may receive video/image data via, for example, the imaging devices 162, user input received via the user interface unit 136 with the user input device 126, or other suitable means. In some embodiments, the computing device 110 may receive at, for example, the data collection unit 132 an indication that a biomanufacturing process has begun and one or more components of the computing device 110 may begin monitoring video/image data provided, e.g., by the imaging devices 162. In some aspects, the data collection unit 132 may apply pre-processing to received video/image data, for example, resizing, re-orienting, color balancing, etc. applied to one or both of training video/image signals or video/image signals, wherein the training video/image signals and the video/image signals respectively correspond to the training video/image data and the video/image data.

The model training unit 134 is generally configured to generate, train, or apply a model. The model may be any suitable model for analyzing video/image data to identify falling or stationary objects. In some embodiments, and as discussed further below, the model may be trained using at least some of the system 100A, or, in some embodiments, the model may be pre-trained (i.e., trained prior to being obtained by the computing device 110). The model may be trained using training video/image data that represent: (i) manufacturing line components, (ii) a manufacturing line floor area, (iii) a manufacturing line interior (e.g., gaps between components, etc.), and/or other suitable areas or portions of areas related to the manufacturing line. In some aspects, the model may include a statistical model, a rules-based model, or other suitable models or combinations thereof to analyze images captured by the imaging device(s) 162 by performing, for example, motion detection on the video/image data. Accordingly, in these aspects, the model may include any suitable image processing algorithm, such as a motion detection algorithm, a dithering algorithm, a feature detection algorithm, a seam carving algorithm, a segmentation algorithm, and/or any other suitable image processing algorithm or combinations thereof.

In other embodiments, the model includes a machine learning model. For example, the model may employ a neural network, such as a convolutional neural network or a deep learning neural network. Other examples of machine-learning models in the model are models that use support vector machine (SVM) analysis, K-Nearest neighbor analysis, naïve Bayes analysis, clustering, reinforcement learning, or other machine-learning algorithms or techniques. Machine learning models included in the model may identify and recognize patterns in training data in order to facilitate making predictions for new data. The model training unit 134 may train the model using the training video/image data that may be received from the training image data sources 150. Of course, generally speaking, the line monitoring application 130 may include any ML models, statistical models, rules-based models, and/or any other suitable models/algorithms in any suitable combination to identify falling objects and/or stationary objects in video/image data.

In particular, when at least one of the models included as part of the line monitoring application 130 is a machine learning model, the model may be universal (i.e., applicable to all circumstances), or may be more specific (i.e., different models for different circumstances). The machine learning model may be trained using a supervised or unsupervised machine-learning program or algorithm. The machine-learning program or algorithm may employ a neural network, which may be a convolutional neural network (CNN), a deep learning neural network, or a combined learning module or program that learns in two or more features or feature datasets in a particular areas of interest. The machine-learning programs or algorithms may also include regression analysis, support vector machine (SVM) analysis, decision tree analysis, random forest analysis, K-Nearest neighbor analysis, naïve Bayes analysis, clustering, reinforcement learning, and/or other machine-learning algorithms or techniques or combinations thereof. In some embodiments, due to the processing power requirements of training machine learning models, the selected model may be trained using additional computing resources (e.g., cloud computing resources) based upon data provided by external sources (e.g., the training image data sources 150). The training data may be unlabeled, or the training data may be labeled, such as by a human. Training of the machine learning model may continue until at least one model of the machine learning model is validated and satisfies selection criteria to be used as a predictive model for identifying a falling object and/or a stationary object within video/image data. In one embodiment, the machine learning model may be validated using a second subset of the training data to determine algorithm accuracy and robustness. Such validation may include applying the machine learning model to the second subset of training data to identify a falling object and/or a stationary object within video/image data in the second subset of the training data. The machine learning model may then be evaluated to determine whether the machine learning model performance is sufficient based upon the validation stage predictions. The sufficiency criteria applied may vary depending upon the size of the training data available for training, the performance of previous iterations of machine learning models, or user-specified performance requirements.

To be most effective, the ML model(s) may be computationally inexpensive to allow for real or near-real-time identification of a falling object and/or a stationary object within video/image data (e.g., be capable of processing and classifying live video/image data at the edge—meaning, by the device itself—or capable of sending video/image data to the cloud for processing in real-time). Within the computational constraint driven by the device specifications, it is generally preferred that the ML model(s) maximize predictive power. Because falling objects and/or stationary objects are uncommon and the impact of detection is substantial (e.g., biomanufacturing process stoppage/delay), the ML model(s) may preferably have exceptionally strong predictive power to avoid false positive events (erroneously identifying a falling object and/or a stationary object in video/image data).

Generally, CNNs are well-suited for machine vision applications due to their pattern recognition capabilities. As will be appreciated, CNNs differ from standard multi-layer perceptrons (MLPs) by using convolutional layers wherein matrices of numbers commonly referred to as filters are convolved with an input image to generate a tensor representing a new image with an arbitrary number of channels. This new tensor can be subsequently convolved with a new set of filters in another convolutional layer, producing yet another tensor. The process repeats for each layer defined in the CNN. In a typical classification task, the final output of a CNN is a vector set representing the predicted likelihood of each class. The filters of the CNN can be trained and selected based on recognizing distinct patterns such as edges, corners, or shapes. Thus, in certain aspects, the ML model(s) included as part of the line monitoring application 130 may be or include a CNN configured to identify a falling object and/or a stationary object within video/image data.

In any event, the user interface unit 136 is generally configured to receive user input. In one example, the user interface unit 136 may generate a user interface for presentation via the display 124, and receive, via the user interface and user input device 126, user-input training video/image data to be used by the model training unit 134 when training the model. In another example, the user interface unit 136 may receive, via a user interface and user input device 126, inputs to start operation of the biomanufacturing process machinery 160 or the imaging devices 162. The user interface unit 136 may also be used to display information. For example, the user interface unit 136 may be used to display an indication of a falling object or a stationary object represented in the video/image data.

The unexpected item detection unit 138 may also apply or access the model trained by the model training unit 134 (or otherwise obtained by the computing device 110 as a pre-trained model) and/or another model/algorithm (e.g., a motion detection algorithm) when analyzing the video/image data to identify a falling object and/or a stationary object. In some embodiments, the unexpected item detection unit 138 begins analyzing video/image data in response to the data collection unit 132 receiving video/image data. The unexpected item detection unit 138 may monitor video/image data as it is collected by the data collection unit 132 in real-time, in near-real-time (i.e., with some buffer), or asynchronously (i.e., after the video/image data is fully collected over a period of interest). It should be understood that when the unexpected item detection unit 138 is referred to as identifying a falling object and/or a stationary object, this also includes detecting that an object has fallen from the manufacturing line and/or is lying stationary on a floor or other surface proximate to the manufacturing line (as the unexpected item detection unit 138 may monitor in real-time).

The notification unit 140 is generally configured to notify a user when a falling object and/or a stationary object has been identified, and/or to notify the user where the falling object and/or the stationary object is located with respect to the manufacturing line. The notification unit 140 may coordinate with the user interface unit 136 to display a notification. The notification unit 140 may send an electronic message (e.g., e-mail, text, etc.) with a notification to a user of the computing device 110 or an external computing device. In some aspects, the notification unit 140 may send control signals to stop operation of the biomanufacturing process machinery 160 if a falling object and/or a stationary object is detected by the unexpected item detection unit 138. In some aspects, the notification may be stored (e.g., in the memory 128), possibly along with other data (such as operation data) related to the biomanufacturing process machinery 160 that may be useful in diagnosing the cause of the falling object and/or the stationary object.

In some aspects, some or all of the functionalities of the line monitoring application 130 may be provided by a third-party (i.e., not on the computing device 110). For example, the machine learning model and/or the other algorithms/models may be hosted by a third-party and the line monitoring application 130 may access the machine learning model and/or the other algorithms/models remotely by sending data (e.g., the video/image data) and receiving data (e.g., an identification of a falling object and/or a stationary object). In such example, the functionality of the unexpected item detection unit 138 may be hosted by the third-party. Turning to a different example, the machine learning model may be trained by a third-party and the line monitoring application 130 may receive the machine learning model remotely from the third-party (e.g., by the computing device 110 receiving one or more elements of the machine learning model, such as weights or architecture). In such example, the functionality of the model training unit 134 may be hosted by the third-party. In other examples, one or more instances of functionality of any of the units 132-140 may be hosted by a third-party, on, for example, a remote server accessible via the network 170.

FIG. 1B depicts various exemplary system configurations 100B for performing line clearance and monitoring in biopharmaceutical processes and applications, in accordance with various aspects disclosed herein. Generally, the exemplary system configurations 100B may correspond to various configurations of several components included in the example system 100A, and/or may include fewer or additional components, as described herein. Each of these configurations 100B may enable the actions described herein for performing line clearance and monitoring, such that some components of each of the configurations 100B may be disposed proximate to a manufacturing line (e.g., imaging devices 170A1), while other components may not need to be disposed proximate to the manufacturing line (e.g., operator workstations 170A5). In particular, the exemplary system configuration 100B may include three distinct configurations: an Internet of Things (IoT) configuration 170A, a full cloud-based configuration 170B, and a local computing configuration 170C.

In the IoT configuration 170A, the system may generally include a set of imaging devices 170A1, a set of computing devices 170A2, a network switch 170A3, a cloud-based platform 170A4, and operator workstations 170A5. The set of imaging devices 170A1 may include any suitable type and/or number of imaging devices configured to capture video/image data corresponding to a manufacturing line or surrounding areas (e.g., a floor area proximate to the manufacturing line) before, during, and/or after operation. Due to the differences in lighting, available space, and other imaging parameters at various locations near and around the manufacturing line, these various locations may require different imaging devices to capture video/image data that is useful for the subsequent analysis described herein to perform line clearance and monitoring. Thus, the set of imaging devices 170A1 may include a variety of cameras and lens hardware that is specifically configured to monitor and capture video/image data specific part(s)/area(s) of the manufacturing line.

These set of imaging devices 170A1 may include, without limitation, standard FOV cameras with variable or fixed zoom, specialized wide angle (e.g., 180°+) lenses/cameras, gyroscopic style cameras, and/or any other suitable imaging device type or combinations thereof. Generally, the standard FOV cameras may be configured to capture video/image data corresponding to general observations of various stations/equipment in a manufacturing line. The specialized wide angle/area of observation cameras may be specifically configured to observe and capture video/image data corresponding to areas of larger physical volumes, such as floor space under the manufacturing line and associated equipment. Gyroscopic style cameras may be configured to capture video/image data that may correspond to observation regions in tighter spaces in and between equipment that other imaging devices are unable to properly capture. In addition to the cameras and lenses themselves, there may be a local camera/image processor to perform computations on images or videos and perform analysis.

The set of computing devices 170A2 may be or include one or more IoT devices, and may be communicatively coupled with one or more other devices (e.g., the set of imaging devices 170A1). For example, the set of computing devices 170A2 may include an interface for connecting to an imaging device (which may be one or more of the set of imaging devices 170A1), and may connect to and/or otherwise interact with a network switch 170A3 configured to transmit data between the set of computing devices 170A2 and the cloud-based platform 170A4. The set of computing devices 170A2 may be chosen for any suitable reason, such as for technical specifications enabling recording and storing of live video/image data while providing remote access and a simple user interface.

Generally, the cloud-based platform 170A4 may be or include any suitable cloud-based computing platform, such as, for example, Amazon Web Services (AWS). The cloud-based platform 170A4 may also include a plurality of web-based services 171A1-A4, that may perform a variety of services corresponding to the video/image data and/or notifications resulting therefrom. For example, in aspects where the cloud-based platform 170A4 is AWS, the plurality of web-based services 171A1-A4 may include, without limitation, AWS IoT Core 171A1, Amazon CloudWatch 171A2, Storage Service (S3) 171A3, and Amazon Cognito 171A4. In some aspects, the cloud-based platform 170A4 may receive video/image data from the set of computing device 170A2 via the network switch 170A3, and the platform 170A4 may apply various algorithms/models to the video/image data to identify a falling object and/or a stationary object within the video/image data.

Further in these aspects, if the cloud-based platform 170A4 successfully identifies the falling object and/or the stationary object within the video/image data, the platform 170A4 may generate and/or cause a notification to be displayed to a user/operator that includes an image from the video/image data of the falling object and/or the stationary object. For example, the cloud-based platform 170A4 may generate a notification by aggregating each image from the video/image data of the falling object and/or the stationary object, and transmitting the aggregated images to the operator workstation 170A5 for display to the user/operator. Additionally, or alternatively, the cloud-based platform 170A4 may simply cause a display (e.g., display 124, display of operator workstation 170A5) to present a notification that includes each image from the video/image data of the falling object and/or the stationary object.

In particular, the cloud-based platform 170A4 may generate and/or cause the notification to be displayed at an operator workstation 170A5 for review by the user/operator. The operator workstation 170A5 may be a computing device/system (e.g., a supervisory control and data acquisition (SCADA) system) that may be communicatively coupled to and/or otherwise configured to control operation of one or more components of the manufacturing line that is monitored by the set of imaging devices 170A1, and the IoT configuration 170A, more generally. Specifically, the operator workstation 170A5 may be configured to communicate and coordinate activities and/or processes between the IoT configuration 170A and the manufacturing line equipment on operations such as timing, equipment operation, start/stop/hold/restart commands, and/or any other suitable commands or combinations thereof.

Broadly speaking, the full cloud-based configuration 170B includes many similar components to the IoT configuration 170A, with several differences. Namely, the full cloud-based configuration 170B utilizes additional cloud-based services 171B1 and 171B2, relative to the IoT configuration 170A, to account for the lack of the set of computing devices 170A2 included as part of the IoT configuration 170A. In particular, and in aspects where the cloud-based platform 170B3 is AWS, the plurality of web-based services 171A1-A4 and 171B1-B2 may include, without limitation, AWS IoT Core 171A1, Amazon CloudWatch 171A2, Storage Service (S3) 171A3, Amazon Cognito 171A4, Amazon Kinesis 171B1, and Amazon EC2 171B2. The Amazon Kinesis 171B1 and Amazon EC2 171B2 web services may generally host an application (e.g., line monitoring application 130) that is configured to perform and/or may otherwise independently perform video/image data processing that would otherwise be performed by the set of computing devices 170A2 in the IoT configuration 170A. Otherwise, the full cloud-based configuration 170B may include a similar or the identical set of imaging devices 170A, the network switch 170A3 connecting the set of imaging devices 170A directly to the cloud-based platform 170A4, and the operator workstation 170A5.

Similarly, the local computing configuration 170C may include similar components to both the IoT configuration 170A and the full cloud-based configuration 170B, with several differences. More specifically, the local computing configuration 170C includes a local computing device 170C1 that may be configured to perform some/all of the video/image data aggregation, processing, and notification generation/transmission that is performed by some combination of the set of computing devices 170A2, the network switch 170A3, and/or the cloud-based platform 170A4 in the IoT configuration 170A and the full cloud-based configuration 170B. Thus, the local computing device 170C1 may receive live/real-time streaming video/image data from the set of imaging devices 170A1, analyze the video/image data in accordance with the various line clearance and monitoring operations/actions described herein, generate notifications corresponding to the video/image data analysis, transmit the notifications and/or the video/image data to the operator workstation 170A5 for display to a user/operator, and/or cause a display of the operator workstation 170A5 to present a notification including video/image data of the falling object and/or the stationary object to a user/operator.

As a consequence of these various exemplary system configurations 100B, it should be understood that the some/all of the processing steps/actions performed as part of line clearance and monitoring operations described herein may be performed remotely (e.g., in a configuration similar or identical to the IoT configuration 170A or the full cloud-based configuration 170B) and/or locally (e.g., in a configuration similar or identical to the local computing configuration 170C).

FIG. 1C depicts another exemplary system configuration 100C for performing line clearance and monitoring in biopharmaceutical processes and applications, in accordance with various aspects disclosed herein. Generally speaking, the exemplary system configuration 100C may correspond to any of the various exemplary system configurations 100B illustrated in FIG. 1B, and more specifically, may correspond the IoT configuration 170A. In particular, the exemplary system configuration 100C generally illustrates how an IoT based architecture may function as a complementary system to the manufacturing line (e.g., manufacturing lines 181A2 and 181B2). The data flow illustrated in FIG. 1C broadly includes data/notifications/commands corresponding to user management, event logging, video/image data transmission and recording, email and text message dispatching, and system operating commands. The exemplary system configuration 100C includes two manufacturing observation regions 180A1 and 180A2, an IoT upload point 180A3, a cloud-based notification/command storage service 180A4, a local computing network 180A5, and a user/operator account 180A6.

More specifically, the two manufacturing observation regions 180A1 and 180A2 may each include multiple production/manufacturing components (e.g., included as part of the manufacturing lines 181A2, 181B2), as well as components configured to monitor the production/manufacturing components. These monitoring components include a set of imaging devices 181A1 and 181B1, a set of IoT topics 181A3 and 181B3, a cloud-based video/image data storage service 181A4 and 181B4, and real-time operator alerts 181A5 and 181B5 that may be generated as a result of video/image data captured by the set of imaging devices 181A1 and 181B1. The set of imaging devices 181A1 and 181B1 may be similar or identical to the imaging devices (e.g., imaging devices 162, set of imaging devices 170A1) described herein.

The IoT topics 181A3 and 181B3 may generally include operational commands related to the manufacturing lines 181A2 and 181B2, such as stop commands, start commands, restart commands, hold commands, and the like. The IoT topics 181A3 and 181B3 may also include and/or otherwise generate/transmit notifications corresponding to motion alerts (e.g., associated with falling objects), device status (e.g., device stopped/halted), and/or other suitable notifications or combinations thereof. Moreover, the IoT topics 181A3 and 181B3 may generally organize the sets of commands and notifications by particular manufacturing lines (e.g., manufacturing lines 181A2 and 181B2), batch identifications (e.g., particular batches of products and/or particular products), imaging device identifications (e.g., particular imaging device of the set of imaging devices 181A1 and 181B1), timestamps, and/or by any other suitable identifier/metric or combinations thereof.

The cloud-based video/image data storage service 181A4 and 181B4 may generally receive video/image data from the set of imaging devices 181A1 and 181B1. More specifically, the cloud-based video/image data storage service 181A4 and 181B4 may receive video/image data representative of motion events and/or other events taking place on or near the manufacturing lines 181A2 and 181B2. Thus, when the IoT upload point 180A3 receives a notification from the IoT topics 181A3 and 181B3 corresponding to a motion alert, the IoT upload point 180A3 may also retrieve and/or otherwise receive the video/image data from the cloud-based video/image data storage service 181A4 and 181B4 for any further processing, storage, and/or to transmit the video/image data to the user/operator account 180A6 through the local computing network 180A5. Of course, in certain aspects, the notification received from the IoT topics 181A3 and 181B3 may include the video/image data.

As part of the notifications generated/transmitted as a result of the IoT topics 181A3 and 181B3, the user/operator account 180A6 may also receive the real-time operator alerts 181A5 and 181B5, as a result of the video/image data captured by the set of imaging devices 181A1 and 181B1. These real-time operator alerts 181A5 and 181B5 may be or include text messages, email messages, line monitoring application messages (e.g., messages received via the line monitoring application 130, as executed on a user/operator computing device), and/or any other suitable type of message or combinations thereof.

As mentioned, the commands, notifications, video/image data, and/other data generated and/or stored in the two manufacturing observation regions 180A1 and 180A2 may be transmitted to the IoT upload point 180A3 for further processing, storage, and/or transmission/routing to relevant components. For example, the IoT upload point 180A3 may transmit notifications and commands received from the IoT topics 181A3 and 181B3 to the cloud-based notification/command storage service 180A4 for storage. The IoT upload point 180A3 may also forward notifications, commands, video/image data, and/or any other data to the local computing network 180A5 for further processing, storage, or user/operator interaction. When the local computing network 180A5 receives the data from the IoT upload point 180A3, the local computing network 180A5 may route the data to an appropriate user/operator account 180A6. Through the user/operator account 180A6, the associated user/operator may view any/all notifications, commands, video/image data received from the local computing network 180A5 and/or as a direct real-time operator alert 181A5 and 181B5.

More specifically, the user/operator account 180A6 may enable the associated user/operator to analyze the data, and generally respond to the data. In certain aspects, the components configured to monitor the production/manufacturing components (e.g., set of imaging devices 181A1 and 181B1 etc.) may be directly integrated with the manufacturing lines 181A2 and 181B2, such that these components may communicate and coordinate with the manufacturing equipment of the manufacturing lines 181A2 and 181B2 on operations such as timing, equipment operation, start/stop/hold/restart commands, and the like. Therefore, in these aspects, the monitoring components may directly influence the operation of and/or otherwise control the manufacturing equipment of the manufacturing lines 181A2 and 181B2, and the user/operator may view commands executed by the monitoring components as data uploaded to the user/operator account 180A6.

Alternatively, in some aspects and as illustrated in FIG. 1C, the components configured to monitor the production/manufacturing components (e.g., set of imaging devices 181A1 and 181B1, IoT topics 181A3 and 181B3, etc.) may be configured in an add-on style of architecture that does not directly communicate with the manufacturing equipment of the manufacturing lines 181A2 and 181B2. In these configurations, the monitoring components may require additional operator input through the user/operator account 180A6 to execute control commands (e.g., timing, equipment operation, start/stop/hold/restart commands). Thus, the configuration illustrated in FIG. 1C may require significantly less integration time than the directly integrated configuration described previously, and may be substantially more modular, such that the configuration illustrated in FIG. 1C may readily apply to various manufacturing lines (e.g., manufacturing lines 181A2 and 181B2).

### Exemplary Imaging Device/System Implementation

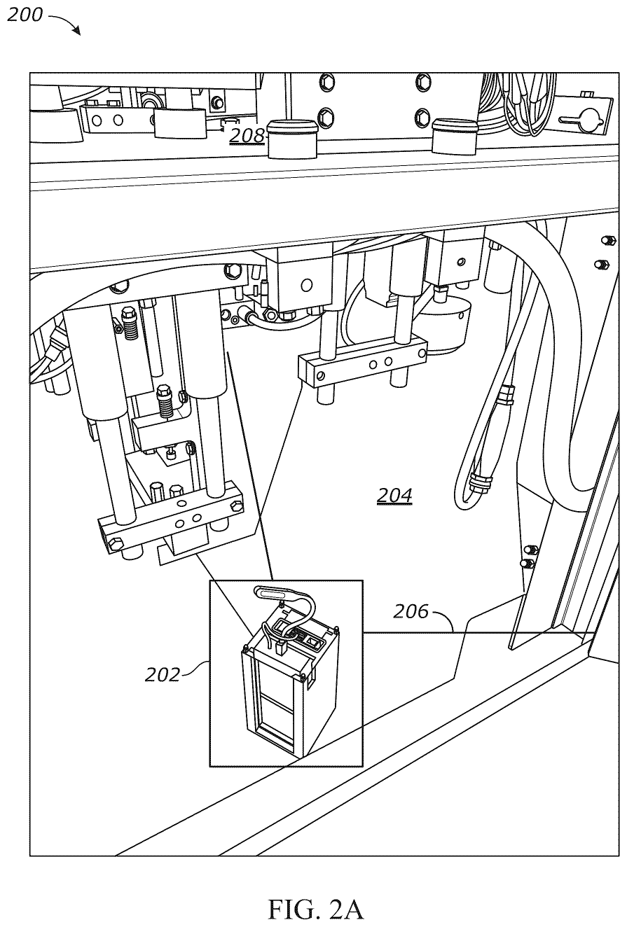

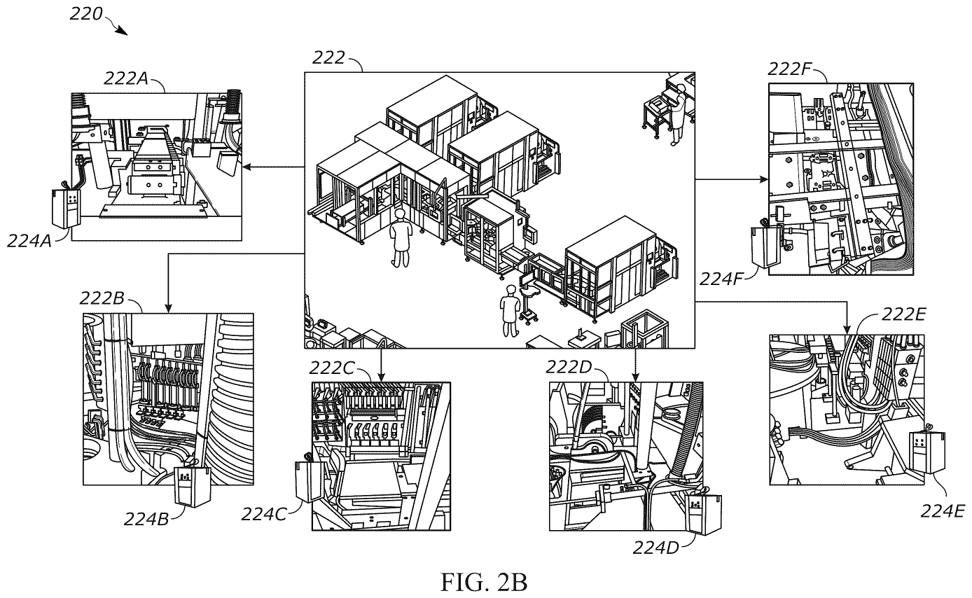

FIG. 2A depicts an example implementation 200 of an imaging device 202 disposed within a manufacturing line to perform line clearance and monitoring, in accordance with various aspects disclosed herein. Generally, the imaging device 202 may be configured to capture real-time video/image data of a floor area 204 that is within a FOV 206 of the imaging device 202. More generally, the imaging device 202 may be a portable device placed as needed within a system, and/or may be integrated within and/or affixed to the manufacturing line equipment 208. In this manner, the imaging device 202 may be positioned, oriented, and configured to capture video/image data that may include, for example, a stationary object that has fallen into the floor area 204 from the overhanging manufacturing line equipment (referenced herein collectively as 208). The imaging device 202 may continually capture video/image data of the floor area 204, and this video/image data may be streamed or periodically uploaded to a processing device (e.g., computing device 110) for analysis. When an object falls from the manufacturing line equipment 208 (or elsewhere) onto the floor area 204, such that the object is within the FOV 206, the live stream video data and/or real-time image data may capture the moment when the object lands in the floor area 204. Accordingly, the systems and methods of the present disclosure may determine when and where the object landed on the floor area 204, and may subsequently perform actions sufficient to clear the object from the floor area 204, as necessary.

Imaging devices identical to and/or similar to the imaging device 202 in FIG. 2A may be positioned at a plurality of locations throughout a manufacturing line to capture video/image data corresponding to any relevant area of the line. For example, FIG. 2B depicts an example implementation 220 of a plurality of imaging devices 224A-F disposed throughout manufacturing line equipment 222 to perform line clearance and monitoring, in accordance with various aspects disclosed herein. As illustrated in FIG. 2B, the manufacturing line equipment 222 may include multiple stations 222A-F, wherein manufacturing components are positioned and configured to perform operations/processes that result in the manufacture of a particular product. Each station 222A-F may perform specific operations that contribute a portion of the overall manufacturing process, such that an unfinished product may enter station 222A and become incrementally completed at each station 222A-F until a finished product exits station 222F.

At each station 222A-F, the corresponding imaging device 224A-F may capture video/image data corresponding to the specific manufacturing line equipment 222 components located at the respective station 222A-F. For example, the imaging device 224B may capture video/image data corresponding to the specific components located at station 222B. Moreover, it should be understood that while the example implementation 220 illustrated in FIG. 2A depicts a single imaging device (e.g., imaging devices 224A-F) at each station 222A-F, there may be multiple imaging devices 224A-F at each station 222A-F. In this manner, the multiple imaging devices 224A-F may capture video/image data corresponding to multiple different FOVs, and may thereby provide a more complete perspective of the manufacturing line equipment 222 and the surrounding areas to more effectively perform line clearance and monitoring. For example, a first imaging device (e.g., imaging device 224C) positioned at station 222C may be positioned/oriented to include equipment/manufacturing components that are part of the manufacturing line equipment 222 within the FOV of the first imaging device, such that the first imaging device captures video/image data corresponding to the equipment/manufacturing components. A second imaging device positioned at station 222C may be positioned/oriented to include a floor area surrounding equipment/manufacturing components that are part of the manufacturing line equipment 222 within the FOV of the second imaging device, such that the second imaging device captures video/image data corresponding to the floor area surrounding the equipment/manufacturing components.

### Exemplary Line Clearance and Monitoring Analysis

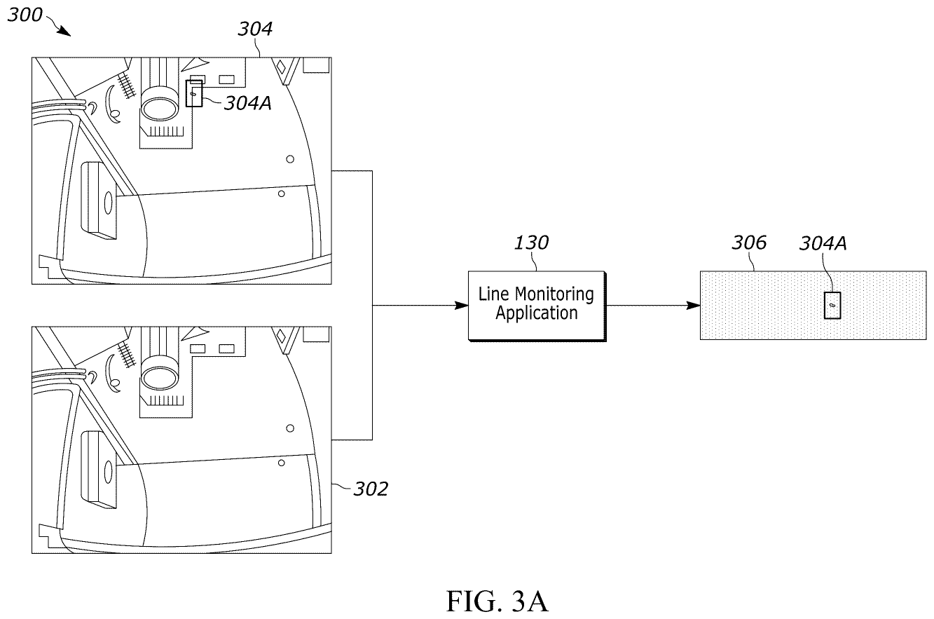

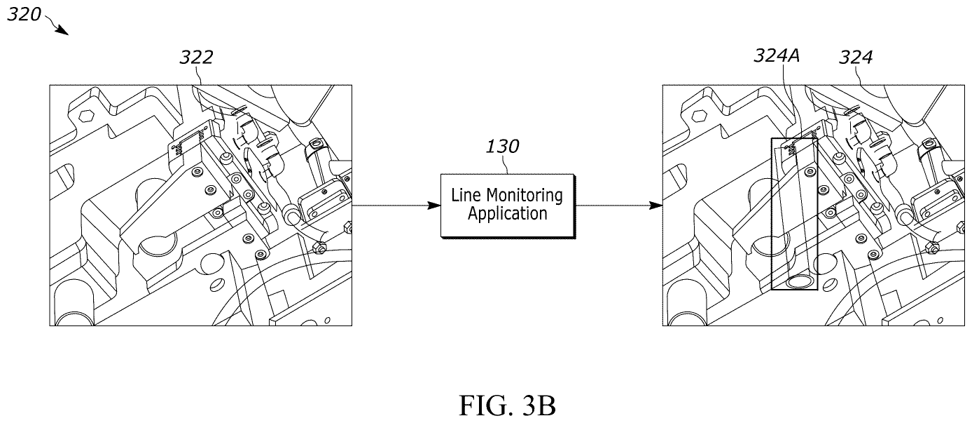

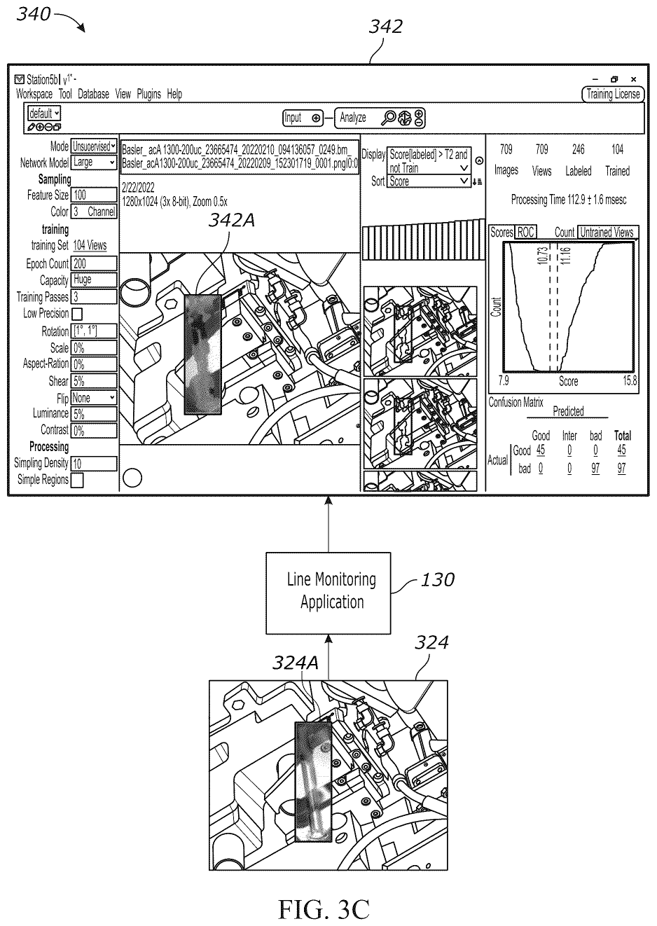

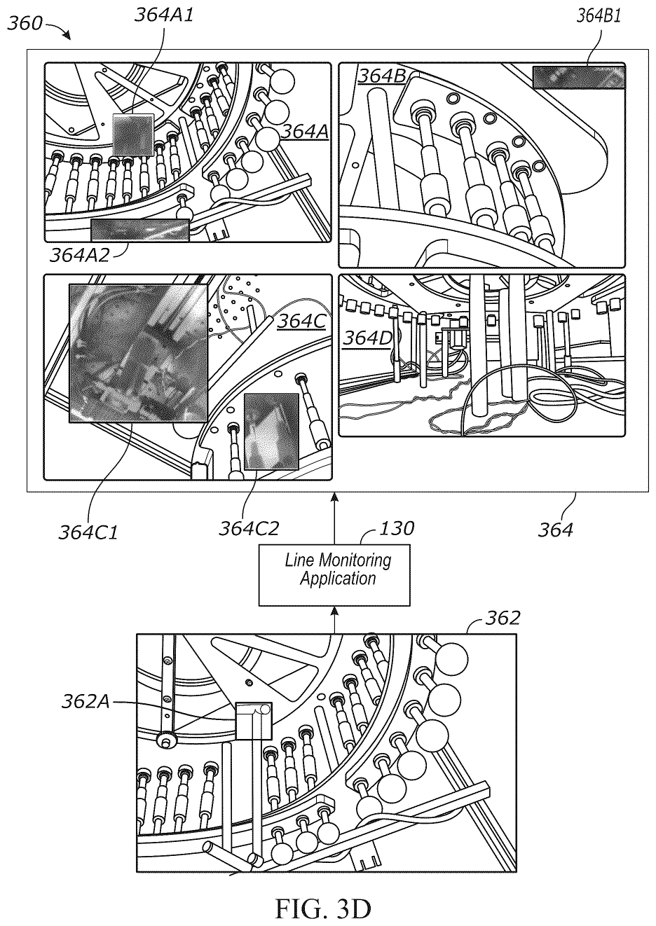

FIG. 3A depicts an example line clearance and monitoring analysis action 300 performed as part of the execution of a line monitoring application (e.g., line monitoring application 130), in accordance with various aspects disclosed herein. The example line clearance and monitoring analysis action 300 generally includes the line monitoring application 130 receiving an initial image 302 of a surrounding area of a manufacturing line, and a subsequent image 304 of the surrounding area that includes a stationary object 304A. For example, the initial image 302 may represent the area surrounding the manufacturing line at a first time instance, where there is no stationary object on the floor or general area surrounding the manufacturing line. At a second time instance, an unexpected object 304A may fall from the manufacturing line and/or otherwise fall through the area surrounding the manufacturing line to land on the floor. Accordingly, the subsequent image 304 may feature the stationary object 304A, and the line monitoring application 130 may record and/or otherwise store the initial image 302 and the subsequent image 304 along with the timestamps corresponding to the first time instance and the second time instance, during which the initial image 302 and the subsequent image 304 were captured.

When the line monitoring application 130 receives the initial image 302 and the subsequent image 304, the application 130 may execute one or more algorithms on the initial image 302 and the subsequent image 304 to identify the stationary object 304A represented in the subsequent image 304. In particular, the line monitoring application 130 may execute a motion detection algorithm on the initial image 302 and the subsequent image 304 to identify the stationary object 304A represented in the subsequent image 304. The motion detection algorithm may include subtracting the initial image 302 from the subsequent image 304, and may thereby generate the subtracted image 306. Generally, if there are multiple pixels that exceed a specified threshold, then an event will be recorded by the line monitoring application 130, and the image data (e.g., initial image 302, the subsequent image 304, and/or the subtracted image 306) may be saved for operator review. In certain aspects, executing the motion detection algorithm may also include applying additional filters to either the initial image 302 and/or the subsequent image 304 to generate the subtracted image 306.

This line monitoring application 130 may also execute the motion detection algorithm to identify falling objects that are captured by imaging devices with high frame capture rates. In general, executing the motion detection algorithm with high frame capture rate imaging devices may result in the line monitoring application 130 having a higher probability of detecting fast moving objects (e.g., falling objects). In certain aspects, the motion detection algorithm may also include a masking feature that will enable the motion detection algorithm to ignore areas of the captured images that may reliably include movement (e.g., a moving conveyor belt), while still enabling the motion detection algorithm to detect objects that leave the area of the conveyer belt.

As previously mentioned, in addition to using motion detection algorithms, other algorithms may be used to perform line clearance and monitoring operations, such as algorithms/models that utilize machine learning (ML) and artificial intelligence (AI). In certain aspects, these AI and ML models may be trained for each imaging device individually, and may be specifically tailored for the specific perspective and FOV the imaging device has on the manufacturing line. Of course, captured images may be processed using these AI/ML models on a local processor (e.g., in local computing configuration 170C), a centralized server located on premise, and/or in a cloud-based server environment (e.g., IoT configuration 170A or full cloud-based configuration 170B), but training these AI/ML algorithms is traditionally difficult as a result of requiring images that display a line clearance problem (e.g., stray containers, vials, or syringes) in the FOV. While it is simple/straightforward to obtain images of manufacturing line equipment during normal operation, it is substantially more difficult for conventional techniques to introduce a line clearance issue (e.g., stray containers) during normal operation, as doing so would venture outside of standard operating procedures written for many manufacturing processes (e.g., FDA approved manufacturing processes). To overcome this difficulty experienced by conventional systems, the present techniques may apply image augmentation techniques that augment images of stray containers to images of manufacturing line equipment taken during normal manufacturing.

To illustrate, FIG. 3B depicts an example line clearance and monitoring analysis action 320 performed as part of the execution of a line monitoring application (e.g., line monitoring application 130), in accordance with various aspects disclosed herein. The example line clearance and monitoring analysis action 320 generally includes the line monitoring application 130 receiving an input image 322 of a component of a manufacturing line, and augmenting the input image 322 with an unexpected item 324A (e.g., a vial) to generate an augmented image 324. Generally, the line monitoring application 130 may augment the input image 322 with the image of the unexpected item 324A utilizing image augmentation techniques including, for example and without limitation, Poisson image blending, seamless cloning, and/or other suitable image augmentation techniques or combinations thereof. When the line monitoring application 130 generates the augmented image 324, the line monitoring application 130 may then use the augmented image 324 to train an AI/ML model to identify falling objects (e.g., the unexpected item 324A) and/or stationary objects (e.g., stationary object 304A).

More specifically, FIG. 3C depicts an example line clearance and monitoring analysis action 340 performed as part of the execution of the line monitoring application 130, in accordance with various aspects disclosed herein. The example line clearance and monitoring analysis action 340 generally represents training inputs and training outputs for training an AI/ML model, as trained and executed by the line monitoring application 130. The training input 324 illustrated in FIG. 3C is the augmented image 324 of FIG. 3B, so the training input 324 also includes the unexpected item 324A that has been augmented into the training input 324 by the line monitoring application 130. Thus, the line monitoring application 130 may input the training input 324 into an AI/ML model to train the AI/ML model to identify falling objects (e.g., the unexpected item 324A) and/or stationary objects (e.g., stationary object 304A). In certain aspects, the AI/ML model that may be trained by the line monitoring application 130 may be or include an anomaly detection model, an image classification model, an object detection model, and/or any other suitable model/algorithm or combinations thereof.

As a result of inputting the training input 324 into the AI/ML model, the model may output training outputs that may be presented as part of a line monitoring graphical user interface (GUI) 342. For example, the line monitoring GUI 342 includes a training output 342A that indicates the AI/ML model correctly identified the falling object within the training input 324. Additionally, the AI/ML model may output a score related to the identification of the falling object within the training input 324. This score may be an anomaly score that generally reflects the confidence with which the AI/ML model identified the anomaly (e.g., the falling object) within the training input 324 as the training output 342A. The AI/ML model may condition identification of a falling object and/or a stationary object within training data (e.g., the training input 324) and/or live data (e.g., data captured during normal operation of a manufacturing line) on an identification threshold stored in the line monitoring application 130. In certain aspects, the identification threshold may be adjusted/set by the user/operator during training and/or before execution of the AI/ML model during normal operation of the manufacturing line.

FIG. 3D depicts yet another example line clearance and monitoring analysis action 360 performed as part of the execution of the line monitoring application 130, in accordance with various aspects disclosed herein. It should be appreciated that, while FIG. 3D shows the heatmap portions 364A1-A2, 364B1, and 364C1-C2 in grayscale shading and/or a patterning, the heatmap portions 364A1-A2, 364B1, and 364C1-C2 are in some embodiments portrayed using color-coding. Regardless, in the example line clearance and monitoring analysis action 360 of FIG. 3D, the line monitoring application 130 may receive a first image 362 that features a portion of a manufacturing line during normal operation with an identified unexpected object 362A. In this example line clearance and monitoring analysis action 360, the line monitoring application 130 may have executed a motion detection algorithm and/or an AI/ML model on the first image 362 to identify the unexpected object 362A.

Regardless, upon identification of the unexpected object 362A, the line monitoring application 130 may access video/image data from some/all of the other imaging devices captured at the same or similar timestamp as the first image 362, and may execute the motion detection algorithm and/or an AI/ML model on the video/image data to identify any additional unexpected objects. In certain aspects, and as illustrated in the example line monitoring GUI 364 of FIG. 3D, the line monitoring application 130 may retrieve and analyze data from three additional imaging devices in order to generate a plurality of heatmaps corresponding to identified unexpected objects within and/or around the manufacturing line. The first GUI image 364A may correspond to the first image 362 when the line monitoring algorithm 130 applies an algorithm configured to generate a heatmap graphical overlay on the first image 362 to generate the heatmap portions 364A1 and 364A2. These heatmap portions 364A1 and 364A2 may correspond to portions of the first GUI image 364A that may include an unexpected object, and the unexpected object 352A may be represented in the first heatmap portion 364A1. Similarly, the second and third GUI images 364B and 364C may include multiple heatmap portions 364B1, 364C1, and 364C2 that also correspond to portions of the GUI images 364B and 364C that may include an unexpected object. The line monitoring application 130 may analyze the fourth GUI image 364D, and may not detect any unexpected objects, such that the fourth GUI image 364D may not include a heatmap graphical overlay.

In certain aspects, the heatmap graphical overlay may also indicate historical regions of the respective FOVs represented by the images of the example line monitoring GUI 364 that have included identified unexpected objects. Accordingly, the first image 362 may influence the historical heatmap graphical overlay represented by the first GUI image 364A by causing the line monitoring application 130 to update the location and/or the depth of color/patterning/etc. representing the heatmap portions 364A1 and 364A2 based on the identified unexpected object 362A within the first image 362. Moreover, the heatmap graphical overlay included as part of the first GUI image 364A, the second GUI image 364B, and the third GUI image 364C may indicate areas within the manufacturing line that may have been the cause of an unexpected object (e.g., unexpected object 362A) within an image (e.g., first image 362).

### Exemplary Notifications

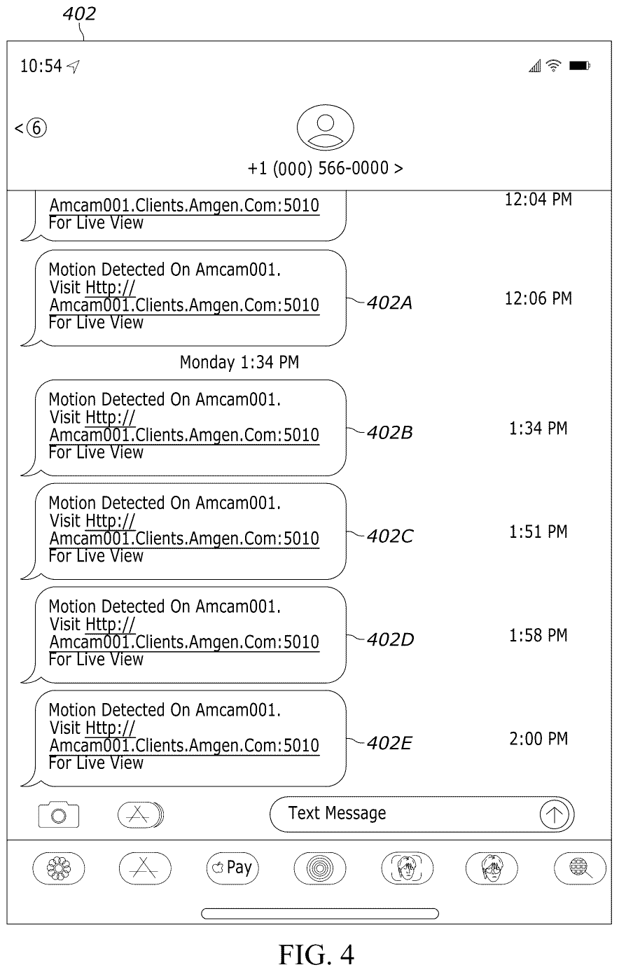

FIG. 4 depicts an example user interface 402, which may be presented by the line monitoring application (e.g., line monitoring application 130) via a display (e.g., display 124), that includes notifications 402A-E to the user, in accordance with various aspects disclosed herein. Generally, the line monitoring application 130 may transmit notifications to and cause the notifications to be presented to a user/operator at a display (e.g., display 124) in response to one of the applied algorithms/models identifying an unexpected object (e.g., a falling object and/or a stationary object) within video/image data representative of the manufacturing line and/or areas surrounding the manufacturing line. For example, the line monitoring application 130 may transmit one or more notifications 402A-E including a link to real-time video/image data that includes the unexpected object to be displayed as part of the user interface 402. When the user interacts (e.g., clicks, taps, swipes, etc.) with the link included in the notification 402A-E, then the line monitoring application 130 may cause the display 124 to display the video/image data including the unexpected object.

In certain aspects, each of the notifications 402A-E may correspond to different events wherein an unexpected object was identified in video/image data of the manufacturing line and/or areas surrounding the manufacturing line. While illustrated in FIG. 4 as text messages, some or all of the notifications 402A-E may additionally or alternatively transmitted by the line monitoring application 130 as an email message and/or as a message within the line monitoring application 130 that the user may access by initiating the line monitoring application 130. In this manner, the user/operator may receive notifications that enable the user to access and analyze real-time video/image data corresponding to an identification of an unexpected object, and to take corrective action, such as executing and/or approving control commands to stop/halt operation of the manufacturing line in order to conduct line clearance operations.

### Exemplary Flow Diagram

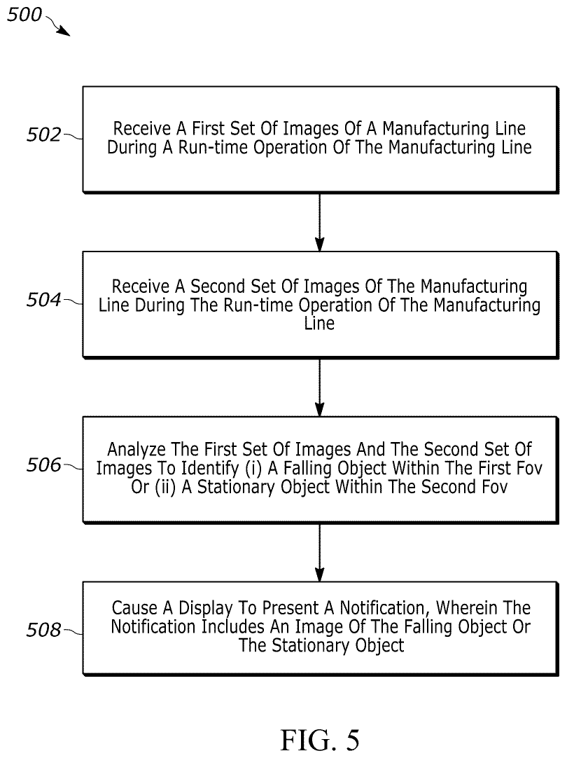

FIG. 5 is a flow diagram depicting an example method 500 for performing line clearance and monitoring in biopharmaceutical processes and applications, in accordance with various aspects disclosed herein. The method 500 may be implemented by one or more components of the system 100A-C, such as the processing unit 120 when executing instructions of the line monitoring application 130, and possibly also the biomanufacturing process machinery 160 (which may be operating a biomanufacturing process). The method 500 may be or include analysis that is the same as or similar to the example line clearance and monitoring analysis actions performed in FIGS. 3A-3C. The example method 500 may generally include the following elements: (1) receiving a first set of images (block 502), (2) receiving a second set of images (block 504), (3) analyzing, by applying a first algorithm, the first set of images to identify a falling object within the first FOV (block 506), (4) analyzing, by applying a second algorithm, the second set of images to identify a stationary object within the second FOV (block 508), and (5) generating a notification for display at a user computing device (block 510).

The method 500 may include receiving a first set of images of a manufacturing line during a run-time operation of the manufacturing line (block 502). The first set of images may represent a first FOV that is oriented to capture objects while falling from the manufacturing line. The method 500 may also include receiving a second set of images of the manufacturing line during the run-time operation of the manufacturing line (block 504). The second set of images may represent a second FOV that is different from the first FOV and oriented to capture objects positioned below the manufacturing line. In some aspects, the method 500 may further comprise capturing the first set of images and the second set of images by at least one of: (i) a variable zoom imaging device, (ii) a fixed zoom imaging device, (iii) a wide angle imaging device, and/or (iv) a gyroscopic imaging device.

The method 500 may further include analyzing the first set of images and the second set of images to identify (i) a falling object within the first FOV or (ii) a stationary object within the second FOV (block 506). The method 500 may further include, responsive to identifying the falling object or the stationary object, causing a display to present a notification, wherein the notification includes an image of the falling object or the stationary object (block 508). In certain aspects, the falling object and the stationary object are a same object, such that the falling object in the first FOV is the same object as the stationary object in the second FOV. Further, in some aspects, the processors performing one or more of the actions included in blocks 502-508 may be cloud-based processors (e.g., hosted on cloud-based platform 170A4).

In some aspects, generating the notification further comprises: responsive to identifying the falling object or the stationary object, triggering, by the one or more processors, a recording of multiple images from either the first set of images or the second set of images, each image of the multiple images depicting the falling object or the stationary object; and causing, by the one or more processors, a display to present the notification, wherein the notification includes the recording.

In certain aspects, the method 500 further comprises: masking a portion of the first set of images or the second set of images prior to analyzing the first set of images or the second set of images, the portion of the first set of images or the second set of images corresponding to one or more moving components of the manufacturing line.

In some aspects, generating the notification further comprises: generating the notification substantially in real-time for display at the user computing device in response to identifying the falling object or the stationary object, wherein the notification comprises at least one of: (i) an email message, (ii) a text message, or (iii) a line monitoring application alert.

In certain aspects, analyzing the first set of images and the second set of images may further comprise analyzing, by the one or more processors, the first set of images by applying a first algorithm and the second set of images by applying a second algorithm to identify (i) the falling object within the first FOV or (ii) the stationary object within the second FOV. In these aspects, both the first algorithm and the second algorithm may be, for example, a motion detection algorithm or a ML algorithm/model. Additionally, in these aspects, the first algorithm may be (i) a motion detection algorithm or (ii) a machine learning (ML) algorithm trained with a plurality of training data comprising a plurality of training images representing the manufacturing line, and wherein the ML algorithm is configured to receive image data of the manufacturing line as input and to output an anomaly score corresponding to a confidence level associated with detection of the falling object or the stationary object; and the second algorithm is (i) the motion detection algorithm or (ii) the ML algorithm. Further in these aspects, the method 500 may further comprise: training the ML model using the plurality of training images representing the manufacturing line, wherein the plurality of training images represent the manufacturing line operating (i) without a falling object within the first FOV and (ii) without a stationary object within the second FOV. Moreover, in these aspects, the ML algorithm may be at least one of (i) an anomaly detection algorithm, (ii) an image classification algorithm, or (iii) an object detection algorithm.

In some aspects, the first algorithm and the second algorithm are included as part of a line monitoring application (e.g., line monitoring application 130); and analyzing the first set of images and the second set of images may be performed by an unexpected item detection unit (e.g., unexpected item detection unit 138) executing instructions comprising the first algorithm and the second algorithm.

In certain aspects, the notification (e.g., notifications 402A-E) may include a heatmap image that comprises a heatmap portion superimposed over the image of the falling object or the stationary object. The heatmap portion may be positioned over the falling object or the stationary object within the image. In certain instances, the notification may include multiple images, and the heatmap image may be multiple heatmap images. In these instances, multiple heatmap portions may be superimposed over the multiple images, such that the notification may include multiple images from the first set of image data and/.or the second set of image data, as well as multiple heatmap images.

In some aspects, the method 500 may be performed either entirely by automation, e.g., by one or more processors (e.g., a CPU or GPU) that execute instructions stored on one or more non-transitory, computer-readable storage media (e.g., a volatile memory or a non-volatile memory, a read-only memory, a random-access memory, a flash memory, an electronic Attorney erasable program read-only memory, or one or more other types of memory). More generally, the method 500 may use any of the components, processes, or techniques of one or more of FIGS. 1-4.

### Additional Considerations

Some of the figures described herein illustrate example block diagrams having one or more functional components. It will be understood that such block diagrams are for illustrative purposes and the devices described and shown may have additional, fewer, or alternate components than those illustrated. Additionally, in various aspects, the components (as well as the functionality provided by the respective components) may be associated with or otherwise integrated as part of any suitable components.

Some aspects of the disclosure relate to a non-transitory computer-readable storage medium having instructions/computer-readable storage medium thereon for performing various computer-implemented operations. The term “instructions/computer-readable storage medium” is used herein to include any medium that is capable of storing or encoding a sequence of instructions or computer codes for performing the operations, methodologies, and techniques described herein. The media and computer code may be those specially designed and constructed for the purposes of the aspects of the disclosure, or they may be of the kind well known and available to those having skill in the computer software arts. Examples of computer-readable storage media include, but are not limited to: magnetic media such as hard disks, floppy disks, and magnetic tape; optical media such as CD-ROMs and holographic devices; magneto-optical media such as optical disks; and hardware devices that are specially configured to store and execute program code, such as ASICs, programmable logic devices (“PLDs”), and ROM and RAM devices.

Examples of computer code include machine code, such as produced by a compiler, and files containing higher-level code that are executed by a computer using an interpreter or a compiler. For example, an aspect of the disclosure may be implemented using Java, C++, or other object-oriented programming language and development tools. Additional examples of computer code include encrypted code and compressed code. Moreover, an aspect of the disclosure may be downloaded as a computer program product, which may be transferred from a remote computer (e.g., a server computer) to a requesting computer (e.g., a computer or a different server computer) via a transmission channel. Another aspect of the disclosure may be implemented in hardwired circuitry in place of, or in combination with, machine-executable software instructions.

As used herein, the singular terms “a,” “an,” and “the” may include plural referents, unless the context clearly dictates otherwise. This description, and the claims that follow, should be read to include one or at least one and the singular also includes the plural unless expressly stated or it is obvious that it is meant otherwise. As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

As used herein, the terms “approximately,” “substantially,” “substantial,” “roughly” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can refer to a range of variation less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, two numerical values can be deemed to be “substantially” the same if a difference between the values is less than or equal to ±10% of an average of the values, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified.

While the techniques disclosed herein have been described with primary to particular operations performed in a particular order, it will be understood that these operations may be combined, sub-divided, or re-ordered to form an equivalent technique without departing from the teachings of the present disclosure. Accordingly, unless specifically indicated herein, the order and grouping of the operations are not limitations of the present disclosure.

1. A computer-implemented method for performing line clearance and monitoring, comprising:
receiving, by one or more processors, a first set of images of a manufacturing line during a run-time operation of the manufacturing line, the first set of images representing a first field of view (FOV) that is oriented to capture objects while falling from the manufacturing line;
receiving, by the one or more processors, a second set of images of the manufacturing line during the run-time operation of the manufacturing line, the second set of images representing a second FOV that is different from the first FOV and oriented to capture objects positioned below the manufacturing line;
analyzing, by the one or more processors, the first set of images and the second set of images to identify (i) a falling object within the first FOV or (ii) a stationary object within the second FOV; and
responsive to identifying the falling object or the stationary object, causing, by the one or more processors, a display to present a notification, wherein the notification includes an image of the falling object or the stationary object.

2. The computer-implemented method of claim 1, wherein generating the notification further comprises:
responsive to identifying the falling object or the stationary object, triggering, by the one or more processors, a recording of multiple images from either the first set of images or the second set of images, each image of the multiple images depicting the falling object or the stationary object; and
causing, by the one or more processors, a display to present the notification, wherein the notification includes the recording.

3. The computer-implemented method of claim 1, further comprising:
masking a portion of the first set of images or the second set of images prior to analyzing the first set of images or the second set of images, the portion of the first set of images or the second set of images corresponding to one or more moving components of the manufacturing line.

4. The computer-implemented method of claim 1, wherein generating the notification further comprises:
generating the notification substantially in real-time for display at a user computing device in response to identifying the falling object or the stationary object, wherein the notification comprises at least one of: (i) an email message, (ii) a text message, or (iii) a line monitoring application alert.

5. The computer-implemented method of claim 1, wherein analyzing the first set of images and the second set of images further comprises:
analyzing, by the one or more processors, the first set of images by applying a first algorithm and the second set of images by applying a second algorithm to identify (i) the falling object within the first FOV or (ii) the stationary object within the second FOV.

6. The computer-implemented method of claim 5, wherein:
the first algorithm is (i) a motion detection algorithm or (ii) a machine learning (ML) algorithm trained with a plurality of training data comprising a plurality of training images representing the manufacturing line, and wherein the ML algorithm is configured to receive image data of the manufacturing line as input and to output an anomaly score corresponding to a confidence level associated with detection of the falling object or the stationary object; and
the second algorithm is (i) the motion detection algorithm or (ii) the ML algorithm.

7. The computer-implemented method of claim 6, wherein the ML algorithm is at least one of (i) an anomaly detection algorithm, (ii) an image classification algorithm, or (iii) an object detection algorithm.

8. The computer-implemented method of claim 6, further comprising:
training the ML algorithm using the plurality of training images representing the manufacturing line, wherein the plurality of training images represent the manufacturing line operating (i) without a falling object within the first FOV and (ii) without a stationary object within the second FOV.

9. The computer-implemented method of claim 1, wherein the notification includes a heatmap image that comprises a heatmap portion superimposed over the image of the falling object or the stationary object, the heatmap portion being positioned over the falling object or the stationary object within the image.

10. The computer-implemented method of claim 1, wherein:
the falling object and the stationary object are a same object.

11. The computer-implemented method of claim 1, wherein the one or more processors include one or more cloud-based processors.

12. The computer-implemented method of claim 1, further comprising:
capturing the first set of images and the second set of images by at least one of: (i) a variable zoom imaging device, (ii) a fixed zoom imaging device, (iii) a wide angle imaging device, and (iv) a gyroscopic imaging device.

13. A computer system for performing line clearance and monitoring, comprising:
one or more processors; and
a program memory coupled to the one or more processors and storing executable instructions that, when executed by the one or more processors, cause the computer system to:
receive a first set of images of a manufacturing line during a run-time operation of the manufacturing line, the first set of images representing a first field of view (FOV) that is oriented to capture objects while falling from the manufacturing line,
receive a second set of images of the manufacturing line during the run-time operation of the manufacturing line, the second set of images representing a second FOV that is different from the first FOV and oriented to capture objects positioned below the manufacturing line,
analyze the first set of images and the second set of images to identify (i) a falling object within the first FOV or (ii) a stationary object within the second FOV, and
responsive to identifying the falling object or the stationary object, cause a display to present a notification, wherein the notification includes an image of the falling object or the stationary object.

14. The computer system of claim 13, wherein the instructions, when executed, further cause the one or more processors to generate the notification by:
responsive to identifying the falling object or the stationary object, triggering a recording of multiple images from either the first set of images or the second set of images, each image of the multiple images depicting the falling object or the stationary object; and
causing a display to present the notification, wherein the notification includes the recording.

15. The computer system of claim 13, wherein the instructions, when executed, further cause the one or more processors to:
mask a portion of the first set of images or the second set of images prior to analyzing the first set of images or the second set of images, the portion of the first set of images or the second set of images corresponding to one or more moving components of the manufacturing line.

16. The computer system of claim 13, wherein the instructions, when executed, further cause the one or more processors to generate the notification by:
generating the notification substantially in real-time for display at a user computing device in response to identifying the falling object or the stationary object, wherein the notification comprises at least one of: (i) an email message, (ii) a text message, or (iii) a line monitoring application alert.

17. The computer system of claim 13, wherein the instructions, when executed, further cause the one or more processors to analyze the first set of images and the second set of images by:
analyzing the first set of images by applying a first algorithm and the second set of images by applying a second algorithm to identify (i) the falling object within the first FOV or (ii) the stationary object within the second FOV, wherein:
the first algorithm is (i) a motion detection algorithm or (ii) a machine learning (ML) algorithm trained with a plurality of training data comprising a plurality of training images representing the manufacturing line,
the ML algorithm is configured to receive image data of the manufacturing line as input and to output an anomaly score corresponding to a confidence level associated with detection of the falling object or the stationary object, and
the second algorithm is (i) the motion detection algorithm or (ii) the ML algorithm.

18. The computer system of claim 17, wherein the instructions, when executed, further cause the one or more processors to:
train the ML algorithm using the plurality of training images representing the manufacturing line, wherein the plurality of training images represent the manufacturing line operating (i) without a falling object within the first FOV and (ii) without a stationary object within the second FOV.

19. A tangible, non-transitory computer-readable medium storing executable instructions for performing line clearance and monitoring, that when executed by one or more processors of a computer system, cause the computer system to:
receiving a first set of images of a manufacturing line during a run-time operation of the manufacturing line, the first set of images representing a first field of view (FOV) that is oriented to capture objects while falling from the manufacturing line;
receiving a second set of images of the manufacturing line during the run-time operation of the manufacturing line, the second set of images representing a second FOV that is different from the first FOV and oriented to capture objects positioned below the manufacturing line;
analyzing the first set of images and the second set of images to identify (i) a falling object within the first FOV or (ii) a stationary object within the second FOV; and
responsive to identifying the falling object or the stationary object, causing a display to present a notification, wherein the notification includes an image of the falling object or the stationary object.

20. The tangible, non-transitory computer-readable medium of claim 19, wherein analyzing the first set of images and the second set of images further comprises:
analyzing, by the one or more processors, the first set of images by applying a first algorithm and the second set of images by applying a second algorithm to identify (i) the falling object within the first FOV or (ii) the stationary object within the second FOV, wherein:
the first algorithm is (i) a motion detection algorithm or (ii) a machine learning (ML) algorithm trained with a plurality of training data comprising a plurality of training images representing the manufacturing line,
the ML algorithm is configured to receive image data of the manufacturing line as input and to output an anomaly score corresponding to a confidence level associated with detection of the falling object or the stationary object, and
the second algorithm is (i) the motion detection algorithm or (ii) the ML algorithm.
